(19) United States
(12) Patent Application Publication
(10) Pub. No.: US 2009/0307407 A1
(43) Pub. Date: Dec. 10, 2009

(54) REMOTE ACCESS TO AN INTERNAL STORAGE COMPONENT OF AN ELECTRONIC DEVICE VIA AN EXTERNAL PORT

(75) Inventor: James D. Bennett, Hroznetin (CZ)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/183,243

(22) Filed: Jul. 31, 2008

Related U.S. Application Data
(60) Provisional application No. 61/058,708, filed on Jun. 4, 2008.

(51) Int. Cl. G06F 13/00

(52) U.S. Cl. 710/316

(57) ABSTRACT

A computing device allows remote access to internal storage component via a remote access interface, e.g., USB, port. The electronic device or computing device contains a motherboard with modified internal circuitry that allows access to the internal storage component via the remote access port. Bus arbitration circuitry, within the motherboard of the computing device, arbitrates between a host CPU and the remote access interface port. Power arbitration circuitry, within the motherboard of the computing device, arbitrates between an internal power supply and power available at the remote access port. The bus arbitration and power arbitration are based upon a predetermined rules as well as an intelligent adaptive set of rules. Internal storage component access is provided based on authorization rules. The internal storage component may be accessed by an external processing circuitry even when the electronic device or computing device is powered down or not in working condition.

### CROSS REFERENCES TO RELATED APPLICATIONS

The present application claims priority under 35 U.S.C. 119(e) to U.S. Provisional Application Ser. No. 61/058,708, filed Jun. 4, 2008, and having a common title with the present application, which is incorporated herein by reference in its entirety for all purposes.

The present application is related to the following U.S. Utility Patent Applications:

Utility application Ser. No. 12/______ filed on even date herewith and entitled “COMPUTER STORAGE COMPONENTS THAT PROVIDE EXTERNAL AND INTERNAL ACCESS” (BP7203), and

Utility application Ser. No. 12/______ filed on even date herewith and entitled “ACCESS OF BUILT-IN PERIPHERAL COMPONENTS BY INTERNAL AND EXTERNAL BUS PATHWAYS” (BP7204), both of which are incorporated herein by reference in their entirety for all purposes.

### BACKGROUND

1. Technical Field

The present invention relates generally to electronic devices; and, more particularly, to electronic devices and computing devices that operate using internal storage devices.

2. Related Art

Internal storage components are integral part of most present day electronic devices and computing devices. Electronic devices and computing devices that utilize at least one internal storage component include personal computers, notebook computers, tablet personal computers, set top boxes, video players, personal video recorders, televisions, palm PCs (Personal Computer), cell phones, PDAs (Personal Digital Assistants) and a variety of media players. Internal storage components that have permanent storage abilities come in many varieties, such as hard disk drives and flash memories.

Internal storage components have limited access, that is, they are accessed for reading and writing, typically only by internal processing circuitry of the electronic device or computing device. This limited accessibility restricts the internal storage components from being used when the device is powered down or not in a working condition. Even when they are in working condition and powered on, the limited accessibility of internal storage components restricts a user from quickly transferring data stored therein to another electronic device or computing device. For example, a user whose first notebook computer is not working, e.g., because it cannot be powered up, cannot access any data stored in it. One of the reasons is that the user is unable to access a hard disk drive that may be present in the first notebook computer. The user may not be able to continue his work using another personal computer or notebook computer unless the hard disk drive of the first computer is accessed by enabling the first notebook computer. The user would typically take the first notebook computer (that is not working) to a computer service center and have the hard disk drive removed and the contents transferred to a Compact Disc (CD), etc. The data recovery causes the user to lose valuable time and thus results in loss of business, work, and/or revenues.

Users sometimes transfer data from one computing device (that may not be operable) to another. One example of such transfer is when a user transfers hard disk drive contents from a personal computer to a notebook computer. Such transfer requires a removable storage device such as a pen drive, a CD (Compact Disc), a DVD (Digital Video Disc) or a portable hard disk drive that is large enough to handle the entire volume of the hard disk drive. Alternatively, the user may use a local area network connection to transfer the hard disk drive contents from one computer to another. A user that is not equipped with these facilities (memory stick, CD, LAN, etc.) or one who does not have enough time to take such measures would be unable to accomplish the data transfer.

Data transfer between computers/PCs/notebooks also requires application software to manage the data transfer between devices, and in particular, requires both computers to have applications that support the data transfer running. Also, sometimes, internal storage components of the computers are not compatible due to construct, size, or other characteristics. In addition, internal storage component drivers may not be available if the internal storage component is moved to a new device where the data is needed, and a custom designed internal storage component may not fit easily. These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic block diagram illustrating a computing device having a motherboard and an internal storage component that support remote access to the internal storage component via a remote access port according to one or more embodiments of the present invention;

FIG. 2 is a schematic block diagram illustrating in detail interface/power arbitration circuitry of a computing device built in accordance with one or more embodiments of the present invention;

FIG. 3 is a schematic block diagram illustrating two devices communicatively coupled via a remote access port in accordance with one or more embodiments of the present invention;

FIG. 4 is a perspective block diagram illustrating a local bus arbitrator of a computing device constructed according to one or more embodiments of the present invention;

FIG. 5 is a flow chart illustrating operation of an authorization unit in accordance with one or more embodiments of the present invention;

FIG. 6 is a flow chart illustrating operation of power arbitration circuitry that may form a portion of a motherboard of a computing device and that operates in accordance with one or more embodiments of the present invention; and

FIG. 7 is a flow chart illustrating operation of bus arbitration circuitry that may form a portion of a motherboard of a computing device and that operates in accordance with one or more embodiments of the present invention.

### DETAILED DESCRIPTION OF THE DRAWINGS

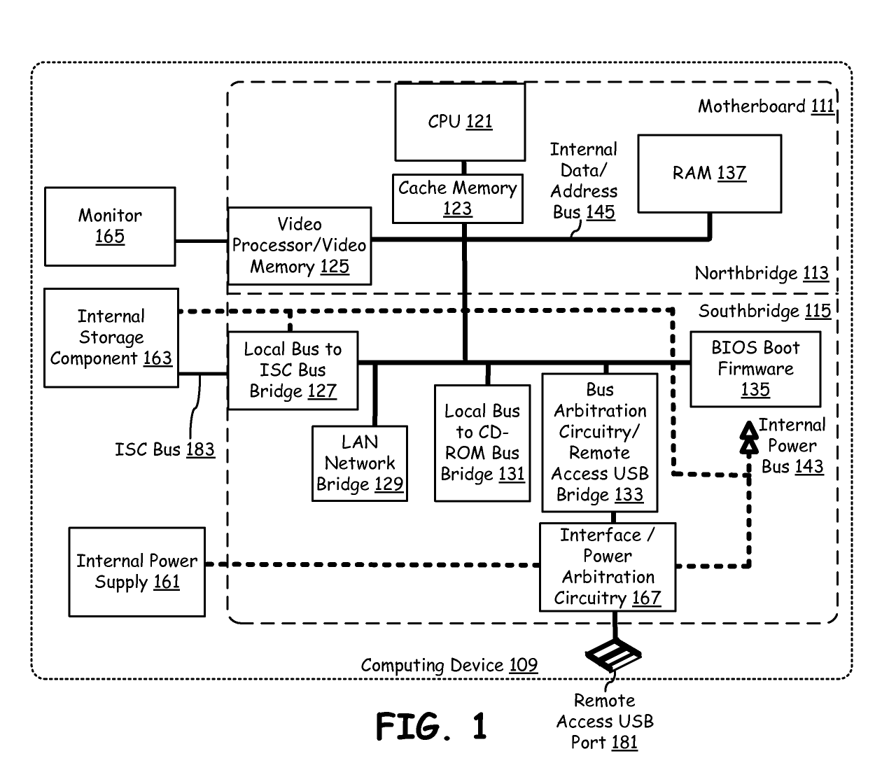

FIG. 1 is a schematic block diagram illustrating a computing device having a motherboard and an internal storage component that support remote access to the internal storage component via a remote access port according to one or more embodiments of the present invention. The computing device 109 includes a motherboard 111, an internal storage component 163, an internal power supply 161, and a monitor 165. Typically, the computing device 109, such as a personal computer or a notebook computer, comprises the motherboard 111 and a plurality of supported devices connected to the motherboard 111 via corresponding cables or wires. These supported devices may include a keyboard (not shown), one or more CD-ROM drives (not shown), a monitor 165, and the Internal Storage Component (ISC) 163. The motherboard 111 and the supported devices are typically powered by the internal power supply 161.

The motherboard 111 is generally divided into a Northbridge portion 113 and a Southbridge portion 115. The Northbridge portion 113 comprises a Central Processing Unit (CPU) 121, a Random Access Memory (RAM) 137, a cache memory 123, and a video processor/video memory 125, which are interconnected using an internal data/address bus 145 or other bus/line structures. The Southbridge portion 115 includes various bridges, such as a local bus to ISC bus 183 bridge 127, a Local Area Network (LAN) network bridge 129, and a local bus to CD-ROM bus bridge 131 and Basic Input-Output System (BIOS) boot firmware 135, which are interconnected using the internal data/address bus 145 or other bus/line structures. The internal power supply 161 powers the motherboard 111 via the interface/power arbitration circuitry 167. The internal power bus 143 reaches each of the components of the motherboard 111 as well as other supported devices.

The computing device 109 supports remote access to the internal storage component 163 via a remote access port 181 according to one or more aspects of the present invention. The remote access port 181 is a Universal Serial Bus (USB) port in some embodiments and is another type of communication port, serial, parallel, or a combination thereof in other embodiments. For example, in other embodiments the remote access port 181 could be any type of serial port, e.g., Firewire port, RS-232 port, RS-485 port, or another type of parallel port, or any type of parallel port, such as an IEEE 1284 parallel port, a Standard Parallel Port, or another type of parallel port, some of which may be modified to support operations of embodiments of the present invention. Further, while the term USB port may be used herein, the reader should appreciate that another type of port may be employed. Remote access to the internal storage component 163 via the remote access port 181 is facilitated by Interface/Power Arbitration Circuitry 167 and a Bus Arbitration Circuitry/Remote access Bridge 133. The present invention makes it possible to also power one or more of these supported devices employing the power provided by an external device via the remote access port 181.

In accordance with the present invention, the remote access port 181 allows external electronic devices such as an external computer or a handheld device to access the internal storage component 163 via the interface/power arbitration circuitry 167 and the bus arbitration circuitry/remote access Bridge 133. In one embodiment of the present invention, the internal storage component 163 is accessed by an external electronic device via the remote access port 181 even when the computing device 109 is switched off or not in working condition. For example, if the computing device 109 is “dead” because the internal power supply 161 does not work any more, has become defective, or is otherwise not working for any reason the internal storage component 163 is still accessible in accordance with the present invention. In some embodiments, the internal storage component 163 receives power from the remote access port 181 through the interface/power arbitration circuitry 167. The interface/power arbitration circuitry 167 built into the motherboard 111 monitors the available power sources and determines the source of power to employ. The arbitration among available sources of power is based upon a set of rules, which may be based on user preferences, etc.

For remote read-write access, an external electronic device is connected to the computing device 109 using the remote access port 181 of the computing device 109. Internal to the computing device 109, the remote access port 181 is communicatively coupled to the Interface/Power Arbitration Circuitry 167, which also couples to the Internal Power Supply 161. The interface/power arbitration circuitry 167 arbitrates between the power coming from the remote access port 181 (presumably from the external electronic device) and the internal power supply 161. The arbitration among such available power sources is based upon priority rules. The Internal Power Bus 143 receives power from the interface/power arbitration circuitry 167.

The bus arbitration circuitry/remote access Bridge 133 decides upon the issue of relegating the bus control either to an internal CPU 121 or to the external device that is connected through the remote access port 181. The arbitration is based on a set of predetermined rules. These rules can be configured and managed by a user or by Information Technology personnel.

For example, a user whose first notebook computer is broken down (say, the first notebook computer is not powering up) is unable to access a hard disk drive of the first notebook computer. To continue working the user would usually take the first notebook computer to a computer service center and get the hard disk drive removed and the contents transferred to a CD (Compact Disc). This entire process makes the user lose valuable time and perhaps to lose business and/or revenue. In accordance with the present invention, the user now just connects a second computer (which can be powered up) to the first notebook computer via an USB cable and remote USB port 181 of the first computer. The user is then able to access the hard disk of the first notebook computer from the second computer—all data needed from the first computer can be easily accessed from the second computer and work can continue, and everything is business as usual.

Another example of the advantages of the present invention is experienced by a user attempting to transfer hard disk drive contents from a first personal computer to a second notebook computer, at a workplace. This would usually require a removable storage device such as a pen drive, CD (Compact Disc), DVD (Digital Video Disc) or a portable hard disk drive that is large enough to handle the entire volume of the necessary hard disc drive contents. Alternatively, the user may require local area network connection to transfer the hard disk drive contents. The user, not being equipped with any of these facilities (a memory stick or LAN connections or security passwords for the LAN) or not having enough time to do so, finds it hard to perform the intended action easily/efficiently in time. In accordance with the present invention, the user now has to just transfer the necessary contents of the hard disk drive of the first personal computer using the second notebook computer, even when the first computer is powered on. The process involved is similar to the one explained in the above paragraph, with reference to the above example. The power and bus arbitration circuitries 167 and 133 built into the first personal computer's motherboard arbitrate and provide read-write access to the second notebook computer on a priority basis. For example, an operating system of the second notebook computer may monitor hard disk drive read-write access and may not allow any modifications to system files that are used by the operating system of the first personal computer.

Thus, the present invention facilitates sharing of files and other types of content stored in a first computer from a second computer (a second electronic device in general) via the remote access port 181 (or other similar ports in general) even when the first computer is active, powered on and usable. The power from the second computer 181 is not delivered via the remote access port 181 if it is not necessary. In addition, bus arbitration is provided for and data access is facilitated via the remote access port 181.

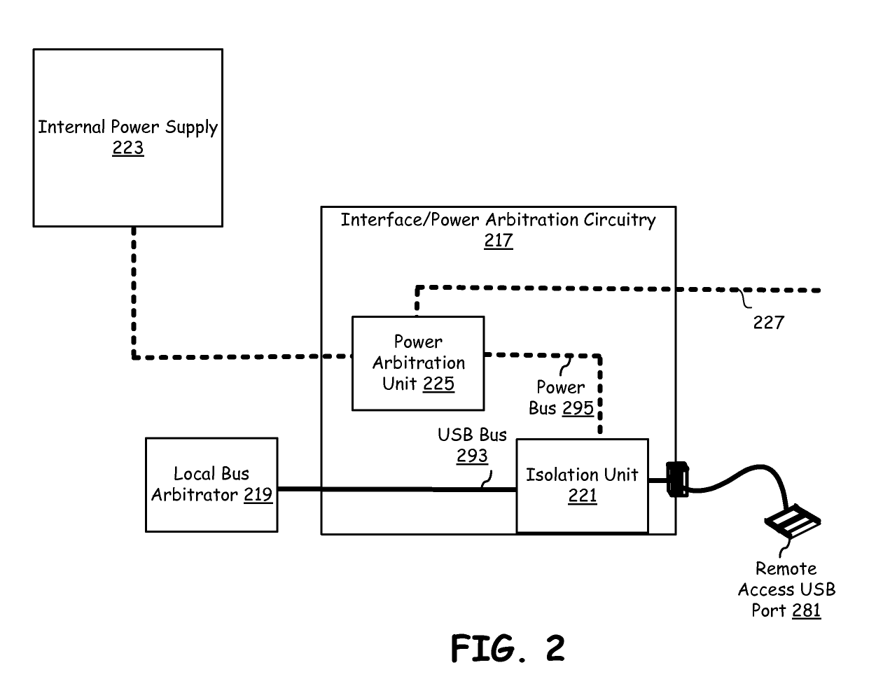

FIG. 2 is a schematic block diagram illustrating in detail interface/power arbitration circuitry of a computing device built in accordance with one or more embodiments of the present invention. FIG. 2 illustrates in detail interface/power arbitration circuitry 217 of a computing device, built in accordance with at least one embodiment of the present invention. An external computing device is connected through a remote access port 281 to interface/power arbitration circuitry 217. The interface/power arbitration circuitry 217 includes a power arbitration unit 225, a power bus 295, an isolation unit 221, and an USB bus 293. The isolation unit 221 separates power and data lines of the external computing device plugged in or communicatively coupled to the computing device under consideration. Power from the external computing device is then connected to the power Arbitration Unit 225, via the power bus 295, which also receives power from an internal power supply 223. The power arbitration unit 225 arbitrates between the two power sources available (i.e. power provided by units 223 and 221). The arbitrated power is used to power other components in the computing device via power bus 227.

The power arbitration is based upon a set of rules. These rules also decide which components of a serviced computer will be powered by the power bus 295. The data bus from the incoming external computing device, after being separated by the isolation unit 221, is then connected to a Local Bus Arbitrator 219 by a USB bus 293. When both power sources (power from the internal power supply 223 as well as power from the external computing device via the isolation unit 221) are available simultaneously, the power arbitration unit 225 arbitrates according to the predetermined set of rules. The logic for such arbitration, for example, comprises providing priority to power provided by the internal power supply 223 and then to power provided by an external computing device. In addition, access to data (or to data buses in general) is arbitrated by the local bus arbitrator 219. The logic for such arbitration, for example, may involve providing a priority to internal processing circuitry or a priority to the external processing circuitry.

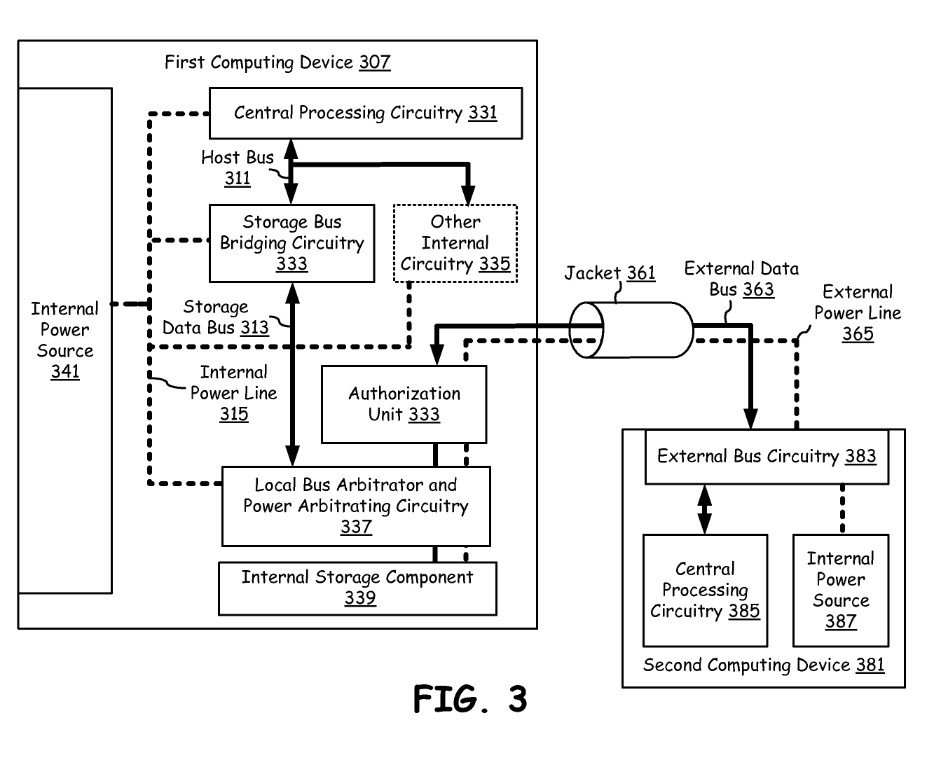

FIG. 3 is a schematic block diagram illustrating two devices communicatively coupled via a remote access port in accordance with one or more embodiments of the present invention. Computing device 307 supports remote access to an internal storage component 339 by a second computing device 381. The structure and operation of FIG. 3 may be employed by any circuitry contained within a Personal Computer, and Personal Digital Assistants (PDA), or another computing device that includes an internal storage component(s). The computing device 307 with the internal storage component 339 comprises a central processing circuitry 331, an internal power source 341, storage bus bridging circuitry 333, the internal storage component 339, an authorization unit 333, local bus arbitrator and power arbitrating circuitry 337, and other internal circuitry 335. The other internal circuitry 335 may include application specific circuitry, for example, random access memory and user interfaces. The internal power source 341 delivers power to all of these internal components via an internal power line(s) 315. Similarly, a host bus 311 and a storage data bus 313 communicatively couple the internal storage component 339 to the central processing circuitry 331 (via the local bus arbitrator and power arbitrating circuitry 337).

The second computing device 381, which might be a personal or notebook computer, is communicatively coupled to the internal storage component 339 of the first computing device 307 via an external data bus 363 and an external power line 365 and components of the first computing device 307. The external data bus 363 and external power line 365 may be part of an USB cable with a jacket 361 and two connectors (not shown) at both ends. The second computing device 381, among other things, includes a central processing circuitry 385, an internal power source 387 and external bus circuitry 383 that bridges internal data, address and a power bus (not shown) to external data bus 363 and external power line 365.

A local bus arbitrator and power arbitrating circuitry 337 in the first computing device 307 arbitrates between the central processing circuitries 331 and 385 when an attempt to access the internal storage component 339 is made. Such arbitration occurs after receiving approval/authentication from the authorization unit 333. Such approval/authentication is based on preferences, rules, and configuration, for example. The central processing circuitry 331 of the first computing device 307 accesses the internal storage component 339 via the local bus arbitrator and power arbitrating circuitry 337, host bus 311 and storage data bus 313. It utilizes power delivered by the internal power source 341 via internal power line 315 when the central processing circuitry 385 of the second computing device 381 (a remote device in general) is not attempting to access the internal storage component 339. When the central processing circuitry 331 of the first computing device 307 is not accessing the internal storage component 339, such as when the computing device 307 is not in working condition or when it is powered off, the central processing circuitry 385 of the second computing device 381 may access the internal storage component 339 utilizing the external data bus 363. The second computer device 381 delivers power to the internal storage component 339 of the first computing device via the external power line 365, the authorization unit 333, and the local bus arbitrator and power arbitrating circuitry 337.

When both central processing circuitry 331 and 385 attempt to access the internal storage component 339 simultaneously, the local bus arbitrator and power arbitrating circuitry 337 arbitrates according to a predetermined set of rules, preferences and configuration. The logic for such arbitration, for example, may involve priority to internal processing circuitry such as 331 under usual circumstances and priority to an external processing circuitry such as the central processing circuitry 385 in other situations.

For example, a personal computer 381 may access the internal storage component 339 of a handheld palm PC 307, even when the handheld palm PC 307 is not in working condition. The user may connect an USB cable to the handheld palm PC 307 and the personal computer to access the contents of the internal storage component 339. Alternatively, a handheld palm PC 381 that is in working condition may also access the hard drive of a personal computer 307 by connecting a USB cable appropriately and deliver power on the external power line 365 and access data on the external data bus 363.

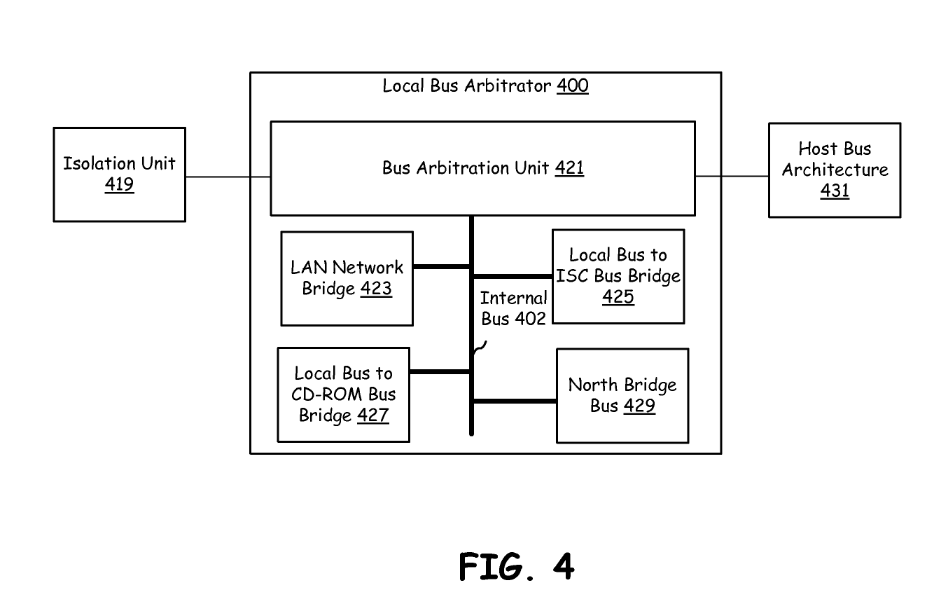

FIG. 4 is a perspective block diagram illustrating a local bus arbitrator of a computing device constructed according to one or more embodiments of the present invention. The local bus arbitrator 417 comprises a bus arbitration unit 421 that couples to host bus architecture 431, to a LAN network bridge 423, a local bus to ISC bus bridge 425, a Northbridge bus 429, and a local bus to CD-ROM bus bridge 427 via an internal bus 402. The bus arbitration unit 421 arbitrates a request to access the internal bus 402 between the host bus architecture 431 and a remote access port (not shown) that uses the isolation unit 419. The isolation unit 419 separates the bus line from the remote access port before connecting it to the bus arbitration unit 421. The arbitration is based upon a set of predetermined rules.

The bus arbitration unit 421 allows the host bus architecture 431 to access the various components of the computing device if there is no request from a remote access port via the isolation unit 419. If the host bus architecture 431 and other components are not powered, the bus arbitration unit 421 receives power, such as from an external computing device, through the remote access port and isolation unit 419, and gives access to internal storage component of the computing device to the external computing device.

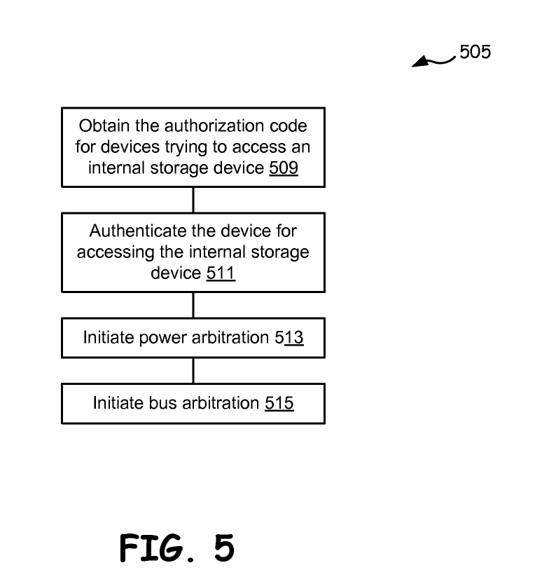

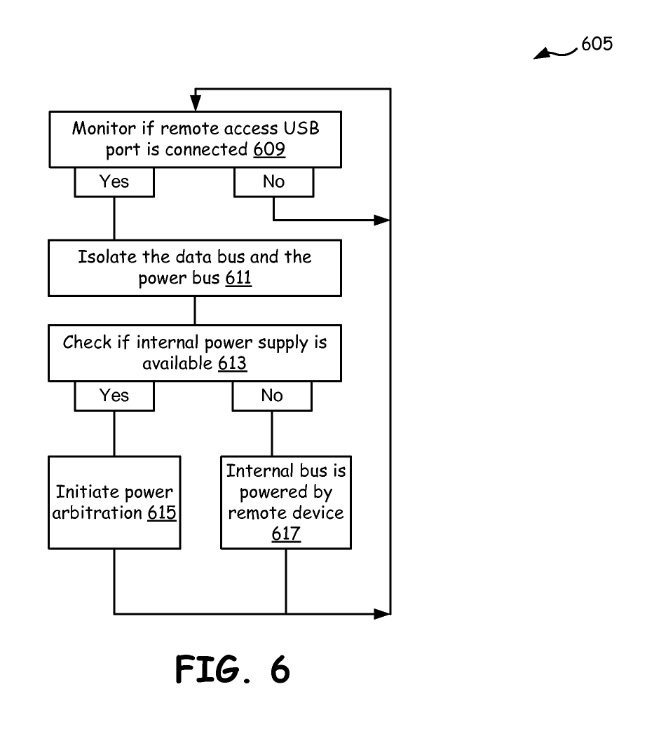

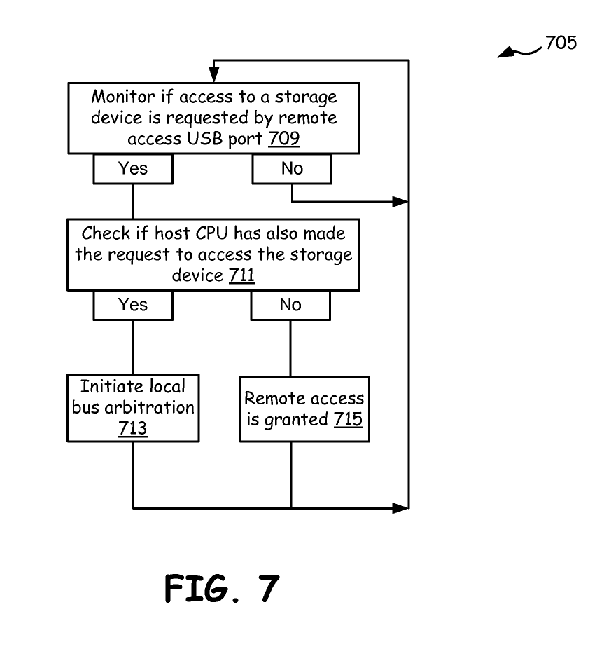

FIG. 5 is a flow chart illustrating operation of an authorization unit in accordance with one or more embodiments of the present invention. The operations 505 of FIG. 5 describe generally the functionality/operation of an authorization unit 333 in accordance with one or more embodiments of the present invention. Operation begins at a block 509 when an authorization unit within a computing device obtains an authorization code for devices trying to access an internal storage component of the computing device. The authorization code may be set based upon priority rules that are intelligent and adaptive. At a next block 511, the authorization unit authenticates the device that is trying to access the internal storage component of the computing device. In one embodiment, obtaining the authorization code comprises challenging the external computing device for an authentication code, which, after retrieval from the external computing device, is compared to a reference code (or compared after a computation, such as hashing) to determine if the external computing device is authenticated. In a related embodiment, the user of the external computing device is prompted to enter an authentication code. At a next block 513, power arbitration circuitry (refer to FIG. 6 for detailed description) of a motherboard of the computing device, arbitrates between available power sources. At block 515 bus arbitration circuitry (refer to FIG. 7 for detailed description) of the motherboard of the computing device arbitrates between host CPU and remote access port.

FIG. 6 is a flow chart illustrating operation of power arbitration circuitry that may form a portion of a motherboard of a computing device and that operates in accordance with one or more embodiments of the present invention. The operations 605 of FIG. 6 illustrate, generally, the functionality of a power arbitration circuitry of a motherboard of a computing device in accordance with one or more embodiments of the present invention. The operations 605 of FIG. 6 begin at block 609 where the computing device or electronic device monitors if there is any external computing device that is connected to a remote access port. For a positive determine, operation proceeds to block 611 where the computing device identifies the external computing device connected to the remote access port and first isolates the data and power bus of the external computing device that is trying to access an internal storage component of the first computing device. For a negative determination at step 609, operation returns to step 609.

At a next block 613, the computing device checks for the availability of an internal power supply. When power from the internal power supply is available internally as well as power from a port accessed by the external computing device (at the remote access port such as an USB port), the power arbitration circuitry provides power derived from one of the two power supply ports connected to it (i.e. the internal power or the external power) based upon arbitration rules, at a block 615. The arbitration rules may be based upon, for example, the power arbitration circuitry determining whether the computing device or electronic device is powered on using an internal battery. In this case, the power arbitration circuitry derives power from external power supply (when the power from an internal power supply is not available). On the contrary, if the computing device (or electronic device) is currently powered by an alternating current socket, then the power arbitration circuitry may derive power from internal power supply. In other words, the power management for the internal storage component is done by the power arbitration circuitry based upon programmed logic.

If an internal power supply is not available, operation proceeds to block 617 where the power arbitration circuitry provides power supply from the remote (external) power supply. If external power supply is not available as determined at step 613, operation proceeds to step 615 with the power arbitration circuitry arbitrating between the two available power sources and selecting power from one of the two sources. In many operations, when the internal power supply is available, the power arbitration circuitry selects the internal power supply to supply power for the computing device.

FIG. 7 is a flow chart illustrating operation of bus arbitration circuitry that may form a portion of a motherboard of a computing device and that operates in accordance with one or more embodiments of the present invention. The operations 705 of FIG. 7 illustrate, generally, the functionality of bus arbitration circuitry of embodiments of the present invention, within may be contained upon a motherboard of a computing device. The operations 705 begin at block 709 where the computing device or electronic device monitors connectivity at a remote access port. If an external computing device is connected to the remote access is requesting access to an internal storage component of the computing device, operation proceeds to step 711. If not, operation remains at step 709.

At block 711, the computing device determines whether a host CPU of the computing device has requested access to the internal storage component. If it is determined that a request to access storage has been received, then processing continues to block 713 where local bus arbitration is initiated. If, at the block 711, it is determined that the local/host CPU does not have a local/host CPU requesting access to a local storage device, then, at a next block 715, access is granted to a remote/external computing device requesting access to the local storage. For example, if the host CPU has not requested to access, such as when the computing device or electronic device is not powered on or not in working condition, the bus arbitration circuitry with power provided by the remote access port, grants permission to the remote access port to access the internal storage component.

When both the host CPU and the remote access port request access to the internal storage component, the bus arbitration circuitry arbitrates between them based on arbitration rules. The arbitration rules may decide the components that can be accessed by the remote access port, duration of the access, and the time at which access should be granted. The logic for such arbitration, for example, may involve priority to internal processing circuitry under usual circumstances and priority to external processing circuitry in other situations. In other words, during power up and other important operating system file accesses, the priority might be for the internal processing circuitry. In other situations, such as playing a media file, the internal storage component bus arbitrator circuitry may arbitrate and multiplex time between the internal processing circuitry and external processing circuitry. For example, the bus arbitration circuitry may grant alternate access for the host CPU and the remote access port based on certain priority rules. In this case, the power arbitration circuitry derives power from external power supply. On the contrary, the bus arbitration circuitry may also provide an intelligent time-sharing access. In other words, the bus arbitration management for the internal storage component is done using intelligent and adaptive priority rules.

When the host CPU and the remote access port are not attempting to access simultaneously, such as when the external processing circuitry is not communicatively coupled to the internal storage component, the bus arbitration circuitry provides access to whichever processing circuitry that makes requests. However, when read-write access request does not come from host CPU, such as when the computing device or the electronic device is powered off or not in working condition, the bus arbitration circuitry provides access to the remote access port, by drawing power via external power line.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A computing network infrastructure that supports a first computing device that is communicatively coupled to a second computing device, the computing network infrastructure comprising:
an internal storage component that is contained within the first computing device;
a power arbitration circuitry, within a mother board of the first computing device;
a bus arbitration circuitry, within the mother board of the first computing device;
the bus arbitration circuitry selectively enables the second computing device to access the internal storage component; and
the power arbitration circuitry selectively enables the internal storage component to draw power from the second computing device.

2. The computing network infrastructure of claim 1, wherein the bus arbitration circuitry arbitrates access to the internal storage component.

3. The computing network infrastructure of claim 2, wherein the bus arbitration circuitry operates upon a preprogrammed set of rules.

4. The computing network infrastructure of claim 2, wherein the bus arbitration circuitry provides access to the internal storage component when both the first computing device and the second computing device are powered on and in working condition.

5. The computing network infrastructure of claim 2, wherein the bus arbitration circuitry allows the second computing device to access the internal storage component when the first computing device is switched off or is inoperable.

6. The computing network infrastructure of claim 2, wherein the bus arbitration circuitry allows the second computing device to access the internal storage component when the first computing device is not in working condition.

7. The computing network infrastructure of claim 1, wherein the power arbitration circuitry arbitrates power delivery to at least the internal storage component based upon a preprogrammed set of rules.

8. The computing network infrastructure of claim 7, wherein the power arbitration circuitry arbitrates between the available sources of power.

9. A computing device that has an internal storage component, a motherboard, and internal processing circuitry, the computing device comprising:
an authorization unit;
power arbitration circuitry, within the mother board of the first computing device;
bus arbitration circuitry, within the mother board, that is communicatively coupled to the internal storage component and arbitrates access to the internal storage component; and
the authorization unit authenticates external processing circuitry and, subsequent to authentication of the external processing circuitry, the power arbitration circuitry and bus arbitration circuitry communicatively coupling the external processing circuitry to the and the internal storage component.

10. The computing device of claim 9 further comprising:
internal processing circuitry communicatively coupled to the bus arbitration circuitry; and
the bus arbitration circuitry arbitrating access to the internal storage component between the internal processing circuitry and the external processing circuitry.

11. The computing device of claim 10, wherein the arbitration is based upon a preprogrammed set of rules.

12. The computing device of claim 9, wherein:
the power arbitration circuitry couples to an internal power source;
the power arbitration circuitry couples to an external power source associated with the external processing circuitry; and
the power arbitration circuitry arbitrates power delivery to the internal storage component between the external power source and the internal power source.

13. The computing device of claim 12, wherein the power arbitrator circuitry arbitrates between the external power source and the internal power source for delivery of power to the internal storage component while the bus arbitration circuitry arbitrates access to the internal storage component between the internal processing circuitry and the external processing circuitry.

14. The computing device of claim 9, wherein the computing device is communicatively coupled to the external processing circuitry via a connector disposed on the first computing device.

15. The computing device of claim 14, wherein the power arbitration circuitry and the bus arbitration circuitry couple to the USB connector.

16. A method performed by interface circuitry in a computing device, the method comprising:
monitoring activity in the computing device to determine whether a remote access port is activated;
determining availability of power at the remote access port and power from a power supply contained within the computing device; and
arbitrating the available power at the remote access port and power from the power supply contained within the computing device.

17. The method of claim 15, wherein the power at the remote access port is used when the power from the power supply within the computing device is unavailable.

18. The method of claim 15, wherein the power at the remote access port is used when the power from the power supply within the computing device is unavailable.

19. The method of claim 15, wherein the remote access port is allowed to access the internal processing circuitry of the computing device.

20. The method of claim 15, wherein the remote access port is allowed to bypass the internal processing circuitry of the computing device while facilitating access to a storage component associated with the computing device.
